(19) United States
(12) Patent Application Publication
(10) Pub. No.: US 2022/0260967 A1
(43) Pub. Date: Aug. 18, 2022

(54) THREE-DIMENSIONAL MODEL TEXTURES

(71) Applicant: Hewlett-Packard Development Company, L.P., Spring, TX (US)

(72) Inventors: Nathan Moroney, Palo Alto, CA (US); Ingeborg Tastl, Palo Alto, CA (US)

(73) Assignee: Hewlett-Packard Development Company, L.P., Spring, TX (US)

(21) Appl. No.: 17/627,942

(22) PCT Filed: Sep. 27, 2019
(86) PCT No.: PCT/US2019/053432

§ 371 Date: Jan. 18, 2022

(51) Int. Cl. G05B 19/4099; G06T 17/00; G06T 15/04; G06T 19/20; G06T 7/13; B29C 64/386; B33Y 50/00

(52) U.S. Cl. CPC G05B 19/4099; G06T 17/00; G06T 15/04; G06T 19/20; G06T 7/13; G05B 2219/35134; B33Y 50/00; G06T 2219/2004; G06T 2207/20092; G06T 2200/04; B29C 64/386

(57) ABSTRACT

An example non-transitory computer-readable medium comprising instructions that, when executed by a processor, cause the processor to generate a first surface based on an edge of a three-dimensional (3D) model. The first surface includes values indicating no displacement at locations of the first surface corresponding to the edge of the 3D model. The instructions, when executed by the processor, cause the processor to merge the first surface with a second surface to produce a third surface. The third surface includes values indicating no displacement at locations of the third surface corresponding to the edge of the 3D model.

### BACKGROUND

Additive manufacturing is a technique to form three-dimensional (3D) objects by adding material until the object is formed. The material may be added by forming several layers of material with each layer stacked on top of the previous layer. Additive manufacturing is also referred to as 3D printing. Examples of 3D printing include melting a filament to form each layer of the 3D object (e.g., fused filament fabrication), curing a resin to form each layer of the 3D object (e.g., stereolithography), sintering, melting, or binding powder to form each layer of the 3D object (e.g., selective laser sintering or melting, multijet fusion, metaljet fusion, etc.), and binding sheets of material to form the 3D object (e.g., laminated object manufacturing, etc.).

### BRIEF DESCRIPTION OF THE DRAWINGS

FIG. 1 is a block diagram of an example system to generate 3D model textures.

FIG. 2 is a block diagram of another example system to generate 3D model textures.

FIG. 3 is a flow diagram of an example method to generate 3D model textures.

FIG. 4 is a flow diagram of another example method to generate 3D model textures.

FIG. 5 is a block diagram of an example computer-readable medium including instructions that cause a processor to generate 3D model textures.

FIG. 6 is a block diagram of another example computer-readable medium including instructions that cause a processor to generate 3D model textures.

FIG. 7 is a perspective view of a plurality of example 3D models with various textures.

### DETAILED DESCRIPTION

A three-dimensional (3D) printer may form a 3D object that includes texture on surfaces of the 3D object. The texture may make the 3D object easier to grip, may improve the flow of fluid (e.g., air, water, etc.) across a surface of the 3D object, may include a label or watermark for the 3D object, or the like. The 3D printer may form the 3D object based on a 3D model. The 3D model may not have a texture initially. A user or automated rules may determine the texture to be applied to the 3D model, and the 3D model may be modified to include the determined texture.

Modifying the 3D model to include the texture may cause the 3D model to no longer be watertight. For example, the modification may raise or lower a first point, such as a triangle vertex, on a surface of the 3D model (e.g., move the first point in a direction along or parallel to a normal vector at the point). A second point adjacent to the first point may not be raised or lowered, for example, because the second point may be on an adjacent face of the surface. As a result, there may be a gap between the first point and the second point that causes the 3D model to no longer be watertight. As used herein, the term “normal vector” refers to a vector that is orthogonal to a plurality of tangents to a point on a surface.

The 3D model may be corrected to be watertight by moving points on the surface of the 3D model to close any gaps. Referring to the previous example, the position of the second point may be displaced to close the gap that was produced by modifying the 3D model to include the texture. However, displacing points on the 3D model may produce a 3D model that is no longer geometrically accurate. Corners, creases, or edges of the 3D model and corresponding lengths and sizes defined by them may no longer match the 3D model before modification. Thus, the 3D model may be watertight or geometrically accurate but not both. Accordingly, the texturing of 3D models to produce textured 3D objects may be improved by producing 3D models that include a particular texture while remaining watertight and geometrically accurate.

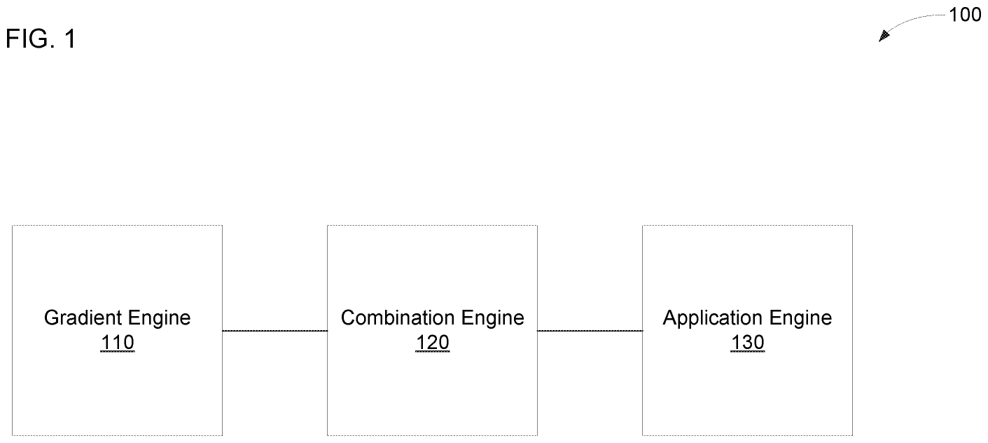

FIG. 1 is a block diagram of an example system 100 to generate 3D model textures. The system 100 may or may not include a 3D printer. The system 100 may include a gradient engine 110, a combination engine 120, and an application engine 130. As used herein, the term “engine” refers to hardware (e.g., analog or digital circuitry, a processor, such as an integrated circuit, or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random-access memory (RAM), a hard-disk or solid-state drive, resistive memory, or optical media such as a digital versatile disc (DVD), and/or executed or interpreted by a processor), or hardware and software hosted at hardware.

The 3D model may include a surface, which may or may not be flat (e.g., may be planar or non-planar). The surface may be at least partially defined by an edge. The edge may be a line, a curve in two-dimensional (2D) or 3D space, or the like and may be a boundary of the surface. The gradient engine 110 may generate an array of displacement values based on the edge of a 3D model. The array may be a two-dimensional set of values that correspond to the surface of the 3D model. The array of displacement values may include values that vary along a gradient starting at a first location in the array corresponding to the edge. For example, a value at the first location in the array corresponding to the edge may have a starting value. A set of additional values in the array of displacement values may be determined based on the starting value and the gradient. As used herein, the term “gradient” refers to a set of values that increase or decrease across a set of adjacent locations. For example, the displacement values may increase traveling away from the edge for some distance. The gradient may or may not be monotonic.

The combination engine 120 may determine a texture for the 3D model by merging the array of displacement values with an initial texture. The initial texture may be a texture selected by a user or automatically selected to be applied to the 3D model. In some examples, the initial texture may be an array of values, or the combination engine 120 may determine an array of values corresponding to the initial texture. The combination engine 120 may merge values from the array of displacement values with corresponding values for the initial texture. The combination engine 120 may merge the values to produce a texture that will not create gaps at the edge.

The application engine 130 may modify the 3D model to have the determined textured, e.g., as if it were applying the initial texture without modification to the 3D model. For example, the texture may be specified as an array of values, and the application engine 130 may displace points on the surface of the 3D model based on the values of the texture. The texture may not produce displacements at the edge of the 3D model, so the application engine 130 may not produce gaps or cause the 3D model not to be watertight when it applies the determined texture. Because the application engine 130 does not create gaps, there is no need to move points and create geometric inaccuracies. Thus, the application engine 130 creates a 3D model that is watertight and geometrically accurate.

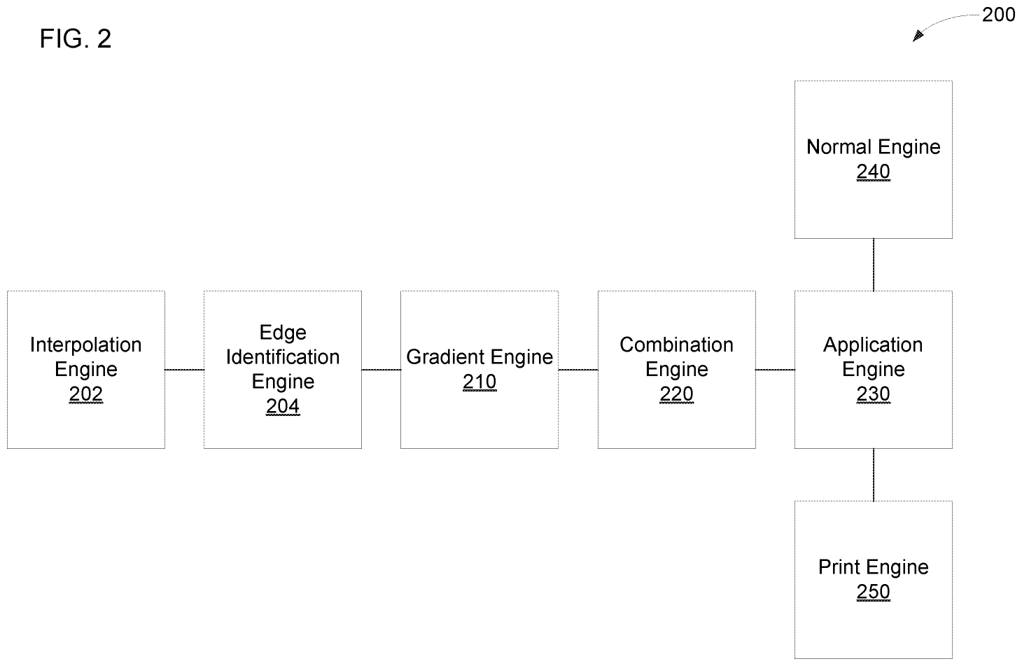

FIG. 2 is a block diagram of another example system 200 to generate 3D model textures. The system 200 may include a 3D printer. The system 200 may include an interpolation engine 202, an edge identification engine 204, a gradient engine 210, a combination engine 220, an application engine 230, a normal engine 240, and a print engine 250. The interpolation engine 202 may increase a number of triangles in an initial 3D model to generate a 3D model. For example, the initial 3D model may be of a low resolution, or a higher resolution may produce a higher quality texture. The interpolation engine 202 may add additional triangle vertices and use interpolation to compute their positions in 3D space.

The edge identification engine 204 may determine an edge of the 3D model. In some examples, the edge identification engine 204 may receive a user indication of the edge of the 3D model. The edge may be a user-defined one-dimensional curve on the surface of the 3D model, a one-dimensional line where two faces of the 3D model meet, a corner, a crease, or the like. For example, a user may specify an arbitrary edge with different textures on each side of the edge. In some examples, the edge identification engine 204 may automatically detect edges, e.g., by detecting discontinuities in tangent or normal vectors at locations on the surface of the 3D model. The edge may be a location where a surface to be textured terminates, and the edge may at least partially define a boundary of the surface. In some examples, the edge may be closed, and the edge may completely define the boundary of the surface.

The gradient engine 210 may generate a first surface based on an edge of a 3D model. The gradient engine 210 may generate the first surface to include values indicating no displacement at locations of the first surface corresponding to the edge of the 3D model. In some examples, the first surface may be specified as an array of displacement values, and the gradient engine 210 may generate the array of displacement values based on the edge of the 3D model. The gradient engine 210 may generate the array of displacement values to include a plurality of values indicating no displacement at locations in the array corresponding to the edge. The encoding values indicating no displacement may be values of zero, values mid-way between a min value and a max value (e.g., a grayscale value of 127 or 128 on a scale of zero to 255), or the like. The selection of encoding value may depend on whether expansion and contraction of the surface to create the texture is permitted.

The gradient engine 210 may determine a gradient based on the edge of the 3D model. The gradient engine 210 may start the gradient at the locations on the first surface, e.g. the locations in the array, that correspond to the edge. The gradient engine 210 may determine a distance over which to apply the gradient (the distance is also referred to herein as a “gradient length”), and the gradient engine 210 may determine a final value at an end of the gradient. The gradient engine 210 may receive the distance and final value from a user, retrieve a predetermined distance and final value, determine the distance and final value from characteristics of the edge (e.g., a size of the surface enclosed by the edge) or a texture to be applied (e.g., a depth or magnitude of variations of the texture), or the like.

The gradient engine 210 may compute values of the gradient varying from an initial value indicating no displacement to the final value over the gradient length. For example, the gradient engine 210 may generate the array of displacement values to include values that vary along the gradient starting at a first location in the array corresponding to the edge and finishing at a second location. The second location may be separated from the first location by the gradient length. Locations in the array corresponding to the edge (e.g., the first location) may have a value indicating no displacement, and locations in the array separated from the edge by the gradient length (e.g., the second location) may have the final value determined by the gradient engine 210.

The gradient engine 210 may determine distances of a plurality of locations in the array from the edge and determine the values that vary along the gradient based on the distances. For example, the gradient engine 210 may select function for the gradient (e.g., a predetermined function). The gradient may be a linear gradient, a clipped signed distance field, a power function weighted gradient, a polynomially varying gradient, an exponentially varying gradient, combinations of different gradients, or the like. The gradient engine 210 may fit the gradient to the initial value, final value, and gradient length. For example, the gradient engine 210 may determine a function that defines the gradient that produces the initial value for a first input and the final value for a second input separated from the first input by the gradient length. To compute values over the gradient length (e.g., values between the first location and the second location), the gradient engine 210 may use the function to compute the gradient value at each location between the first and second locations according to the distance of that location from the first or second location. For example, the gradient engine 210 may use the distance of each location in the array from the edge as the input to the function, and the output from the function may specify the value. Thus, the gradient engine 210 may produce a gradient between the first and second location that varies from the initial value to the final value according to the specified gradient.

An area of uniform displacements may begin at the second location. The gradient engine 210 may set locations in the array of displacement values farther from the edge than the gradient length (e.g., locations beyond the second location) to a uniform/constant value. For example, the gradient engine 210 may set the locations in the array of displacement values farther from the edge than the gradient length to the final value. The first surface created by the gradient engine 210 (e.g., the array of displacement values) may include values that indicate no displacement at the edge, values that vary according to a gradient over the gradient length from the edge, and values that equal a uniform/constant value beyond the gradient length.

The combination engine 220 may merge the first surface with a second surface to produce a third surface. For example, the second surface may be an initial texture, and the combination engine 220 may determine a texture for the 3D model by merging the array of displacement values specifying the first surface with the initial texture. Said another way, the combination engine 220 may modify a texture to be applied to the 3D model based on the gradient. The modification of the texture based on the gradient prevents the texture from changing locations of points in the 3D model corresponding to the edge of the 3D model when the texture is applied to the 3D model.

In some examples, the first surface may include a first array of displacement values, and the initial texture may include or be converted to a second array of values. For example, the first and second surfaces may be defined by first and second arrays of grayscale values. The initial texture may have a same size and shape as the first array of displacement values, or the combination engine 220 may convert the initial texture to an array of values and upsample or downsample the array of values to match the size and shape of the array of displacement values. The combination engine 220 may merge the first and second surfaces by merging values at corresponding locations in the first and second arrays.

The combination engine 220 may merge the first and second arrays by having values from the first array dominate near the edge and having values from the second array dominate away from the edge. For example, the combination engine 220 may merge the first array of displacement values and the initial texture by applying a first weight to each displacement value in the first array of displacement values and a second weight to each of a plurality of corresponding values in the second array of the initial texture. The combination engine 220 may weight values of the first surface more heavily at locations near the edge of the 3D model and weight values of the second surface more heavily at locations far from the edge of the 3D model. The combination engine 220 may determine the first and second weights based on the distance from the edge of the 3D model. The combination engine 220 may use a large or unity value for the first weight at the edge (e.g., the first location) and a small or zero value for the second weight, and the combination engine 220 may use a small or zero value for the first weight at the gradient length from the edge (e.g., the second location) and a large or unity value for the second weight. The combination engine 220 may smoothly transition the weights between the first and second locations. For example, the combination engine 220 may vary the weights linearly based on distance from the edge, vary the weights using the gradient function, or the like.

Thus, the combination engine 220 may generate a third surface that includes values indicating no displacement at locations of the third surface corresponding to the edge of the 3D model. The combination engine 220 may ensure the first surface dominates at the edges of the 3D model to prevent the third surface from creating a displacement at the edge of the 3D model that could create a gap or otherwise cause the 3D model to not be watertight. The combination engine 220 may allow the second surface to dominate away from the edges of the 3D model so that the texture away from the edges matches or is similar to the initial texture. The gradient in the first surface or smooth variation in weights may provide a transition without rapid changes in values or unnatural features in the third surface.

The application engine 230 may modify the 3D model to have the determined texture. For example, the application engine 230 may apply the texture as modified by the first surface to the 3D model. In some examples, the application engine 230 may displace points on the surface of the 3D model in the direction of a normal vector to apply the texture. The normal engine 240 may determine a normal of the surface of the 3D model to receive the texture. For a flat surface (e.g., planar surface), the normal engine 240 may determine a single normal vector for the surface of the 3D model. For a non-flat surface (e.g., non-planar surface), the normal engine 240 may determine normal vectors at a plurality of locations on the surface of the 3D model (e.g., each location to be displaced by the application engine 230).

The normal engine 240 may provide the single normal vector or normal vector for each location to the application engine 230. The application engine 230 may displace points on the 3D model in a direction of the normal vector based on the texture. For example, the texture may include or be specified as a plurality of displacement values (e.g., an array of displacement values). The application engine 230 may displace points on the 3D model in a direction of the normal vector according to the plurality of displacement values. For example, the application engine 230 may displace each point on the 3D model by the displacement value at a corresponding location in an array. The value may specify how far in the direction of the normal vector the point should be displaced. Displacement into or out of the 3D model may be specified by positive or negative values respectively, values more or less than a midpoint between a min value and a max value (e.g., grayscale values more or less than a midpoint), or the like.

The print engine 250 may 3D print the 3D model. For example, the print engine 250 may convert the 3D model with the applied texture to a format that can be 3D printed. The print engine 250 may generate a plurality of slices based on the 3D model. The print engine 250 may form a 3D object as a plurality of layers corresponding to the plurality of slices. Because the 3D model with the applied texture includes the texture, is watertight, and is geometrically accurate, the 3D object will also include the texture, be watertight, and be geometrically accurate.

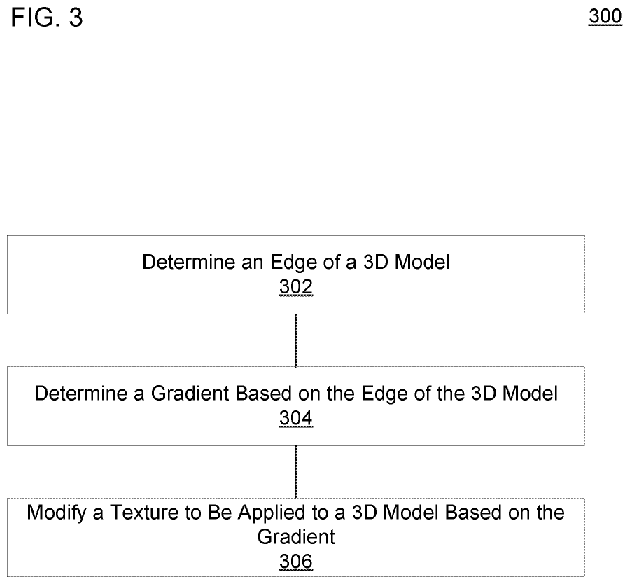

FIG. 3 is a flow diagram of an example method 300 to generate 3D model textures. A processor may perform elements of the method 300. At block 302, the method 300 may include determining an edge of a 3D model. The edge may at least partially define the boundary of a surface of the 3D model. Determining the edge may include determining the edge automatically, receiving a user input indicating the edge, or the like.

At block 304, the method 300 may include determining a gradient based on the edge of the 3D model. Determining the gradient may include determining a region of the surface that should vary according to the gradient and the shape and size of the gradient over that region. The region of the surface may be determined based on the location of the edge of the 3D model. Determining the gradient may include generating a surface or array of values that specify the gradient.

At block 306, the method 300 may include modifying a texture to be applied to the 3D model based on the gradient. For example, modifying the texture may include limiting the amount of displacement caused by the texture based on values of the gradient at corresponding locations. The modification of the texture based on the gradient may prevent the texture from changing locations of points in the 3D model corresponding to the edge of the 3D model when the texture is applied to the 3D model. For example, the texture may not displace points on the edge of the 3D model, so gaps will not result that could cause the 3D model to not be watertight. Referring to FIG. 2, in an example, the edge identification module 204 may perform block 302, the gradient engine 210 may perform block 304, and the combination engine 220 may perform blocks 306.

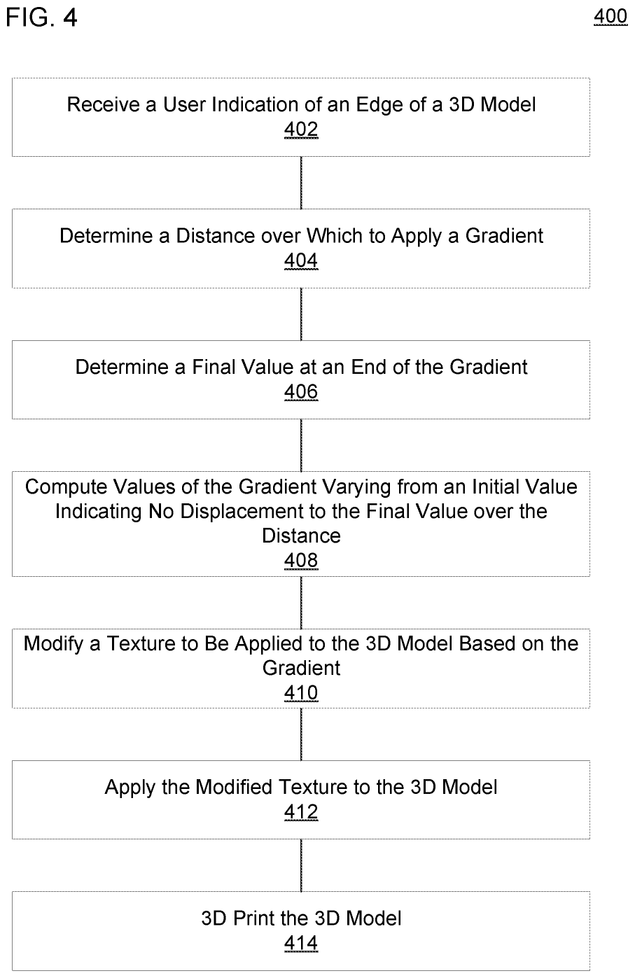

FIG. 4 is a flow diagram of another example method 400 to generate 3D model textures. A processor may perform elements of the method 400. At block 402, the method 400 may include receiving a user indication of an edge of the 3D model. For example, a user interface may present the 3D model to the user, and the user may select locations on the 3D model corresponding to the edge. The edge may be a corner, a crease, a location where faces of the 3D model meet, a discontinuity in a tangent or normal, an arbitrary user specified curve, or the like.

At block 404, the method 400 may include determining a distance over which to apply a gradient (the distance is also referred to herein as a “gradient length”). Determining the distance may include receiving a user indication of the distance, retrieving the distance from a storage device, automatically determining the distance, or the like. The distance may be determined based on characteristics of the surface or the texture, such as a size of the surface, a maximum, average, or median displacement of the texture, or the like. For example, the distance may be larger for larger surfaces and smaller for smaller surfaces, and the distance may be larger for textures with larger displacements and smaller for textures with smaller displacements.

At block 406, the method 400 may include determining a final value at an end of the gradient. Determining the final value may include receiving a user indication of the final value, retrieving the final value from a storage device, automatically determining the final value, or the like. The final value may be determined based on characteristics of the texture, such as a maximum, average, or median displacement of the texture, or the like.

At block 408, the method 400 may include computing values of the gradient varying from an initial value indicating no displacement to the final value over the distance. Computing the values may include computing the values along a line perpendicular to the edge (e.g., along a normal vector to the edge) starting at a location on the edge and ending at a location that is the gradient length from the edge. The location on the edge may have a value indicating no displacement, and the location that is the gradient length from the edge may have a value equal to the final value. The gradient may be defined by a function, and computing the values may include computing values that vary according to the function from the value indicating no displacement to the final value. For example, computing the values may include determining parameters for the function and using the function with those parameters to compute the value at each location between the edge and the location that is the gradient length from the edge. Although block 408 is described with reference to a line, a single starting location, and a single ending location, computing the values may include computing a 2D array of values. The value for each location may be determined based on the distance of the location from the nearest point on the edge. The values may be computed in various orders, which may be independent of the distance of any particular location from the edge.

At block 410, the method 400 may include modifying a texture to be applied to the 3D model based on the gradient. Modifying the texture may include merging the gradient with the texture. For example, a value of the gradient at each location may be combined with a displacement value for the texture at a corresponding location. The value of the gradient and the value for the texture may each be weighted when combining the values. The gradient may be weighted more heavily near the edge, and the texture may be weighted more heavily near locations that are the gradient length from the edge. Accordingly, the modification of the texture based on the gradient may prevent the texture from changing locations of points in the 3D model corresponding to the edge of the 3D model when the texture is applied to the 3D model. The weighting may cause gradient values indicating no displacement to be dominant at the edge of the 3D model and the texture to be dominant at locations near or further away than the gradient length from the edge.

At block 412, the method 400 may include applying the modified texture to the 3D model. The modified texture may be specified as or convertible into an array of displacement values indicating how much to displace each point along a normal vector. Accordingly, applying the modified texture may include displacing each point along the normal vector for that point by the amount indicated by a corresponding location in the array.

At block 414, the method 400 may include 3D printing the 3D model. In some examples, the 3D model with the applied texture may be printed in the same manner as any other 3D model. The 3D model may be watertight, so it may not need to be modified to make it watertight. 3D printing the 3D model may include generating a plurality of slices based on the 3D model and forming the 3D object as a plurality of layers corresponding to the slices. In an example, the edge identification engine 204 of FIG. 2 may perform block 402, the gradient engine 210 may perform blocks 404, 406, and 408, the combination engine 220 may perform block 410, the application engine 230 may perform block 412, and the print engine 250 may perform block 414.

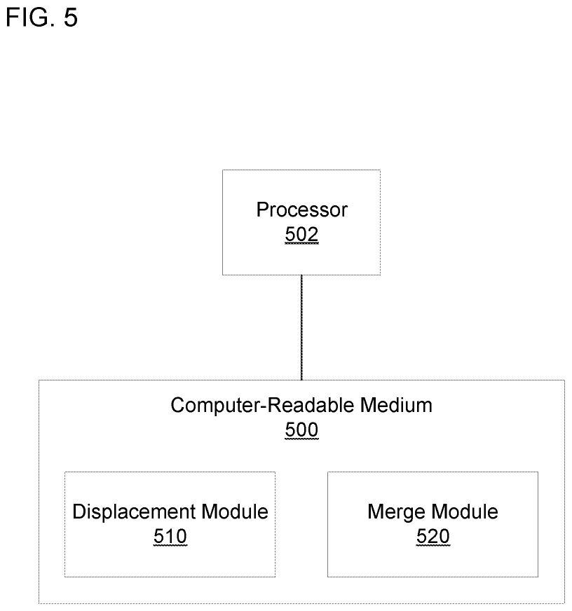

FIG. 5 is a block diagram of an example computer-readable medium 500 including instructions that, when executed by a processor 502, cause the processor 502 to generate 3D model textures. The computer-readable medium 500 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 502 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc.

The computer-readable medium 500 may include a displacement module 510 and a merge module 520. As used herein, a “module” (in some examples referred to as a “software module”) is a set of instructions that when executed or interpreted by a processor or stored at a processor-readable medium realizes a component or performs a method. The displacement module 510 may include instructions that, when executed, cause the processor 502 to generate a first surface based on an edge of a three-dimensional (3D) model. For example, the first surface may specify the amount of displacement that can occur at various locations. The first surface may include values indicating no displacement at locations of the first surface corresponding to the edge of the 3D model. The displacement module 510 may cause the processor 502 to determine locations corresponding to the edge and set the values for those locations to values that indicate no displacement. The values may be values indicating the amount of displacement in a direction of a normal vector, positions in 3D space, or the like.

The merge module 520 may cause the processor 502 to merge the first surface with a second surface to produce a third surface. In some examples, the second surface may be a texture to be applied to the 3D model. The merge module 520 may cause the processor 502 to combine values from the first surface with corresponding values from the second surface to produce values for the third surface. The merge module 520 may cause the processor 502 to combine the values to produce a third surface that includes values indicating no displacement at locations of the third surface corresponding to the edge of the 3D model. The merge module 520 may cause the processor 502 to have values from the first surface dominate during merging for locations near the edge of the 3D model. Accordingly, the third surface may inherit the values indicating no displacement from the first surface. In an example, when executed by the processor 502, the displacement module 510 may realize the gradient engine 110 of FIG. 1, and the merge module 520 may realize the combination engine 120.

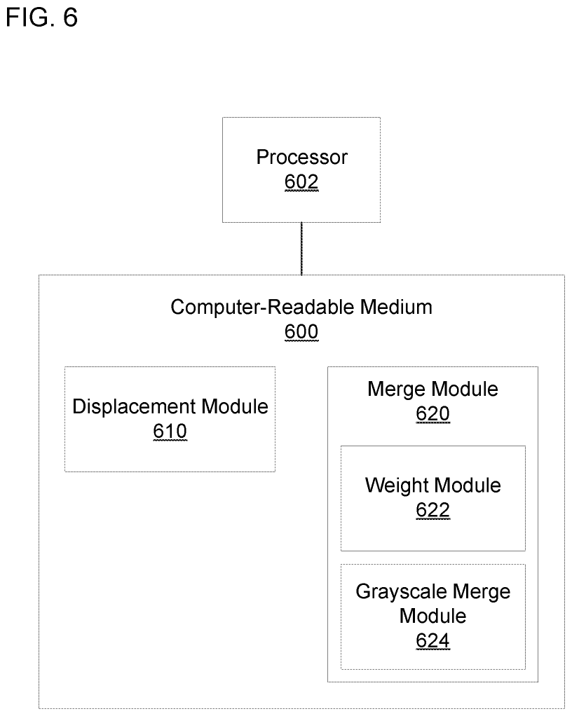

FIG. 6 is a block diagram of another example computer-readable medium 600 including instructions that, when executed by a processor 602, cause the processor 602 to generate 3D model textures. The computer-readable medium 600 may include a displacement module 610, a merge module 620, a weight module 622, and a grayscale merge module 624.

The displacement module 610 may cause the processor 602 to generate a first surface based on an edge of a three-dimensional (3D) model. The edge may be a user-defined one-dimensional curve on the surface of the 3D model, a one-dimensional line where two faces of the 3D model meet, a corner, a crease, or the like. The edge may indicate at least a portion of the boundary of a surface on the 3D model that is to receive a texture. The first surface may have a same size or shape as the surface of the 3D model bounded by the edge. The first surface may include values indicating no displacement at locations of the first surface corresponding to the edge of the 3D model. For example, the displacement module 610 may cause the processor 602 to generate a first surface of the appropriate size or shape and then set values for the first surface. The displacement module 610 may cause the processor 602 to set values at locations of the first surface corresponding to the edge to be values indicating no displacement. The displacement module 610 may cause the processor 602 to set values at locations near the edge to vary along a gradient according to the distance of those locations from the edge. The displacement module 610 may cause the processor 602 to set values at locations more than a particular distance from the edge to be equal to a uniform/constant value.

The merge module 620 may cause the processor 602 to merge the first surface with a second surface to produce a third surface. The merge module 620 may include a weight module 622 and a grayscale module 624. The second surface may be a texture to be applied to the 3D model. For example, the merge module 620 may cause the processor 602 to receive a user indication of the texture, automatically select the texture, or the like. The merge module 620 may cause the processor 602 to apply weights to values from the first and second surfaces when merging the first and second surfaces. The weight module 622 may cause the processor 602 to determine the weights. The weight module 622 may cause the processor 602 to weight values of the first surface more heavily at locations near the edge of the 3D model and weight values of the second surface more heavily at locations far from the edge of the 3D model.

The weight module 622 may cause the processor 602 to determine weights that will cause the third surface to include values indicating no displacement at locations of the third surface corresponding to the edge of the 3D model. For example, the weight module 622 may cause the processor 602 to determine weights that will cause the values of the third surface to equal the values of the first surface at the edge. The weight module 622 may cause the processor 602 to select weights that transition along the gradient from values of the first surface having more impact on the values of the third surface to values of the second surface having more impact on the values of the third surface. In some examples, the weight module 622 may cause the processor 602 to select weights that will cause the values of the third surface to equal the values of the second surface at locations where the first surface is the uniform/constant value.

The merge module 620 may cause the processor 602 to apply the determined weights to the first and second surfaces and to sum corresponding values from the first and second surface to determine the values for the third surface. In some examples, the first and second surfaces may be defined by first and second arrays of grayscale values. The grayscale module 624 may cause the processor 602 to merge the first and second surfaces by merging grayscale values at corresponding locations in the first and second arrays. For example, the grayscale module 624 may cause the processor 602 to apply the weights to the grayscale values and sum or average the weighted values. The merge module 620 may cause the processor 602 to set the value at each location of the third surface equal to the merged value determined from the values from the corresponding locations of the first and second surface. Referring to FIG. 2, in an example, when executed by the processor 602, the displacement module 610 may realize the gradient engine 210, and the merge module 620, the weight 622, and the grayscale module 624 may realize the combination engine 220.

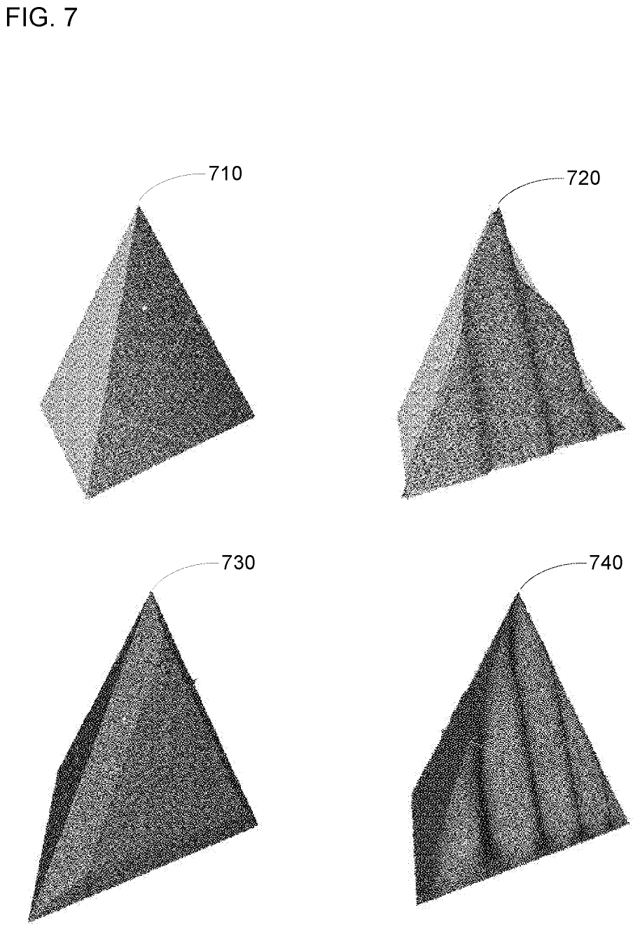

FIG. 7 is a perspective view of a plurality of example 3D models with various textures. A first 3D model 710 may be a 3D model with no texture applied to the 3D model. In the illustrated example, the first 3D model 710 includes a plurality of flat faces (e.g., planar faces), but other examples may include non-flat faces (e.g., non-planar faces).

A second 3D model 720 may be the first 3D model 710 with a sinusoidal texture applied to it without any gradient to prevent gaps from forming. Accordingly, the second 3D model 720 may include a plurality of gaps and may not be watertight.

A third 3D model 730 may be the first 3D model 710 with a gradient surface applied to it. In the illustrated example, the gradient is a linear gradient that varies constantly with distance, but other examples may have non-linear gradients.

A fourth 3D model 740 may be the first 3D model 710 with a merged surface applied to it. The merged surface may be a surface produced by merging the sinusoidal texture with the gradient surface. The amount of displacement of the merged surface may taper down from the displacements of the sinusoidal texture to no displacement as the texture approaches the edge of the face of the fourth 3D model 740.

The above description is illustrative of various principles and implementations of the present disclosure. Numerous variations and modifications to the examples described herein are envisioned. Accordingly, the scope of the present application should be determined only by the following claims.

What is claimed is:

1. A system comprising:
a gradient engine to generate an array of displacement values based on an edge of a three-dimensional model, wherein the array of displacement values includes values that vary along a gradient starting at a first location in the array corresponding to the edge;
a combination engine to determine a texture for the 3D model by merging the array of displacement values with an initial texture; and
an application engine to modify the 3D model to have the determined texture.

2. The system of claim 1, wherein the array of displacement values includes a plurality of values indicating no displacement at locations in the array corresponding to the edge, and wherein the gradient starts at the locations in the array corresponding to the edge.

3. The system of claim 1, wherein the gradient engine is to determine distances of a plurality of locations in the array from the edge and determine the values that vary along the gradient based on the distances, and wherein the combination engine is to merge the array of displacement values and the initial texture by applying a first weight to each displacement value in the array of displacement values and a second weight to each of a plurality of corresponding displacement values for the initial texture.

4. The system of claim 1, wherein the gradient finishes at a second location, and wherein an area of uniform displacements begins at the second location.

5. The system of claim 1, further comprising an interpolation engine to increase a number of triangles in an initial 3D model to generate the 3D model.

6. The system of claim 1, further comprising a normal engine to determine a normal of a surface of the 3D model to receive the texture, wherein the texture includes a plurality of displacement values, and wherein the application engine is to displace points on the 3D model in a direction of the normal according to the plurality of displacement values.

7. A method, comprising:
determining an edge of a three-dimensional (3D) model;
determining a gradient based on the edge of the 3D model; and
modifying a texture to be applied to the 3D model based on the gradient, wherein modification of the texture based on the gradient prevents the texture from changing locations of points in the 3D model corresponding to the edge of the 3D model when the texture is applied to the 3D model.

8. The method of claim 7, wherein determining the edge comprises receiving a user indication of the edge of the 3D model.

9. The method of claim 7, wherein the gradient is selected from the group consisting of a linear gradient, a polynomially varying gradient, and an exponentially varying gradient.

10. The method of claim 7, wherein determining the gradient includes determining a distance over which to apply the gradient, determining a final value at an end of the gradient, and computing values of the gradient varying from an initial value indicating no displacement to the final value over the distance.

11. The method of claim 7, further comprising applying the modified texture to the 3D model, and 3D printing the 3D model.

12. A non-transitory computer-readable medium comprising instructions that, when executed by a processor, cause the processor to:
generate a first surface based on an edge of a three-dimensional (3D) model, the first surface including values indicating no displacement at locations of the first surface corresponding to the edge of the 3D model; and
merge the first surface with a second surface to produce a third surface, the third surface including values indicating no displacement at locations of the third surface corresponding to the edge of the 3D model.

13. The computer-readable medium of claim 12, wherein the instructions that cause the processor to merge the first and second surfaces include instructions that cause the processor to weight values of the first surface more heavily at locations near the edge of the 3D model and weight values of the second surface more heavily at locations far from the edge of the 3D model.

14. The computer-readable medium of claim 12, wherein the edge is one of: a user-defined one-dimensional curve on the surface of the 3D model or a one-dimensional line where two faces of the 3D model meet.

15. The computer-readable medium of claim 12, wherein the first and second surfaces are defined by first and second arrays of grayscale values, and wherein the instructions cause the processor to merge the first and second surfaces by merging values at corresponding locations in the first and second arrays.
